(19) United States
(12) Patent Application Publication
(10) Pub. No.: US 2016/0114646 A1
(43) Pub. Date: Apr. 28, 2016

(54) COLD STORAGE HEAT EXCHANGER

(71) Applicant: DENSO CORPORATION, Kariya-city, Aichi-pref. (JP)

(72) Inventors: Takashi DANJYO, Kariya-city (JP); Takayuki WATANABE, Anjo-city (JP); Shin NISHIDA, Anjo-city (JP)

(21) Appl. No.: 14/895,171

(22) PCT Filed: May 28, 2014
(86) PCT No.: PCT/JP2014/002811

§ 371 Date: Dec. 1, 2015

(30) Foreign Application Priority Data
Jun. 3, 2013 (JP) 2013-117041
Apr. 16, 2014 (JP) 2014-084932

(51) Int. Cl. B60H 1/00

(52) U.S. Cl. CPC B60H 1/005

(57) ABSTRACT

A cold storage heat exchanger that exchanges heat with air flowing therearound includes: a refrigerant passage through which refrigerant flows; and a cold storage body housing a cold storage medium that exchanges heat with refrigerant flowing through the refrigerant passage and stores an amount of heat from the refrigerant. The cold storage medium includes: a low carbon number paraffin comprising at least one of C12 paraffin and C13 paraffin; and a high carbon number paraffin comprising at least one of C15 paraffin and C16 paraffin. A concentration of the high carbon number paraffin in the cold storage medium is higher than 60 percent by weight and lower than 100 percent by weight. A concentration of the low carbon number paraffin in the cold storage medium is higher than 0 percent by weight and lower than 40 percent by weight.

### CROSS REFERENCE TO RELATED APPLICATIONS

This application is based on Japanese Patent Application No. 2013-117041 filed on Jun. 3, 2013 and Japanese Patent Application No. 2014-84932 filed on Apr. 16, 2014, the disclosures of which are incorporated herein by reference.

### TECHNICAL FIELD

The present disclosure relates to a cold storage heat exchanger for a refrigerating cycle.

### BACKGROUND ART

A refrigeration cycle device is driven by a propulsion engine in an air conditioning device for a vehicle. When the engine stops while the vehicle is temporarily stopped, the refrigeration cycle device stops. In order to achieve an improvement in fuel consumption, there has been an increase in so-called idle-stop vehicles in which the engine is stopped while the vehicle is stopped, such as when waiting at traffic lights. In this kind of idle-stop vehicle, comfortableness in the vehicle interior is affected by the stop of the refrigeration cycle device while the vehicle is stopped (while the engine is stopped). If the engine is restarted in order to maintain the air-conditioning while the vehicle is stopped, the improvement in fuel consumption is hindered.

In PTL 1, an interior heat exchanger is provided with a cold storage function in order to maintain an air-conditioned sensation even while the engine is stopped. Specifically, a cold storage container including a cold storage medium is disposed behind an evaporator in flow of air in PTL 1. By so doing, cold heat is stored while a vehicle is travelling, and cold air thereof is used while the vehicle is stopped.

PTL 2 describes that a small-capacity cold storage container including a cold storage medium is provided adjacent to a tube configuring a refrigerant path of an evaporator. PTL 3 describes a normal paraffin having solidifying and melting characteristics stable for a long period, and the normal paraffin having high latent heat is used as a cold storage medium.

### PRIOR ART LITERATURES

### Patent Literature

PTL 1: JP 2009-526194 A
PTL 2: JP 2002-274165 A
PTL 3: JP 2002-337537 A

### SUMMARY OF INVENTION

As an issue of an air conditioning device at the time of idle-stop, in addition to a worsening in the thermal sensation in the vehicle interior, a smell accompanying the evaporation of condensed water adhering to the evaporator has been raised. The temperature of the evaporator rises when the compressor stops at the time of idle-stop, and the smell is generated from a point at which the temperature becomes higher than the wet-bulb temperature of the intake air. If utilizing a cold storage medium with a melting point lower than the wet-bulb temperature of the intake air, the temperature of the evaporator can be maintained at or below the wet-bulb temperature of the intake air while the cold storage medium is melting. Thus, the smell can be restricted.

However, in the conventional art considering of maintaining a cooling sensation during idle-stop, a cold storage medium with a high melting point is used such that the cooling sensation can be maintained for a long time. Consequently, the temperature around the evaporator is at or below the melting point of the cold storage medium for a period during which the external temperature is at or below the melting point, for example, from an intermediate period through winter. At this time, the cold storage medium is constantly solidified and cannot be melted, so the smell cannot be restricted.

Furthermore, paraffin is used as the cold storage medium, which is chemically stable and can be solidified by the cold heat of the evaporator. However, a paraffin that can balance restriction of smell generation and maintenance of comfort has not existed.

An object of the present disclosure is to provide a cold storage heat exchanger in which a generation of smell can be restricted over a wide range of air temperatures while a cold storage function can be maintained.

According to an aspect of the present disclosure, a cold storage heat exchanger that exchanges heat with air flowing therearound includes a cold storage body housing a cold storage medium. The cold storage medium includes a low carbon number paraffin and a high carbon number paraffin. A concentration of the high carbon number paraffin in the cold storage medium is in a range higher than 60 percent by weight and lower than 100 percent by weight. A concentration of the low carbon number paraffin in the cold storage medium is in a range higher than 0 percent by weight and lower than 40 percent by weight.

According to the present disclosure, a cold storage medium includes a low carbon number paraffin and a high carbon number paraffin. The low carbon number paraffin has a comparatively low melting point, while the high carbon number paraffin has a comparatively high melting point. At least two kinds of paraffins with differing melting points are used as the cold storage medium at the previously described concentrations by weight, such that the temperature range over which the cold storage medium solidifies and melts can be widened. Because of this, the cold storage medium can melt and release cold heat even when the air temperature is low. Consequently, when the air temperature is low, the temperature of evaporator can be maintained at or below the wet-bulb temperature of air passing through, whereby the generation of a smell accompanying the evaporation of condensed water can be restricted. Also, as the temperature range over which the cold storage medium can store and release cold heat is wide, the cold storage function can be maintained over a wider range of air temperatures.

### BRIEF DESCRIPTION OF DRAWINGS

FIG. 1 is a front view showing an evaporator of a first embodiment.

FIG. 2 is a side view showing the evaporator of the first embodiment.

FIG. 3 is a partially enlarged sectional view taken along a line III-III of FIG. 1.

FIG. 4 is a graph showing a relationship between melting point and latent heat when C16 and C14 are mixed.

FIG. 5 is a graph showing a relationship between latent heat and temperature of a cold storage medium of the first embodiment.

FIG. 6 is a graph showing a relationship between blow-off temperature and time elapsed.

FIG. 7 is a graph showing a relationship between idle-stop time and air temperature.

FIG. 8 is a graph showing a relationship between phase change distance and cold storage time.

FIG. 9 is an enlarged sectional view showing a cold storage container of the first embodiment.

FIG. 10 is an enlarged sectional view showing a state where a part of the cold storage medium of the first embodiment is solidified.

FIG. 11 is a graph showing a relationship between the temperature of the cold storage medium of the first embodiment and cold storage time.

FIG. 12 is a graph showing a relationship between latent heat and temperature of a cold storage medium of a second embodiment.

FIG. 13 is a graph showing a relationship between latent heat and temperature of a cold storage medium of a third embodiment.

FIG. 14 is a graph showing a relationship between latent heat and temperature of a cold storage medium of a fourth embodiment.

FIG. 15 is a graph showing a relationship between latent heat and temperature of a cold storage medium of a fifth embodiment.

FIG. 16 is a graph showing a relationship between latent heat lowering rate and mixture rate of an unavoidable admixture in the cold storage medium of the fifth embodiment.

FIG. 17 is an enlarged front view showing an evaporator of a sixth embodiment.

FIG. 18 is an enlarged sectional view showing an evaporator of a seventh embodiment.

FIG. 19 is an enlarged sectional view showing an evaporator of an eighth embodiment.

### DESCRIPTION OF EMBODIMENTS

Embodiments of the present disclosure will be described hereafter referring to drawings. In the embodiments, a part that corresponds to a matter described in a preceding embodiment may be assigned with the same reference numeral or by adding one character, and redundant explanation for the part may be omitted. When only a part of a configuration is described in an embodiment, another preceding embodiment may be applied to the other parts of the configuration. The parts may be combined even if it is not explicitly described that the parts can be combined. The embodiments may be partially combined even if it is not explicitly described that the embodiments can be combined, provided there is no harm in the combination.

### First Embodiment

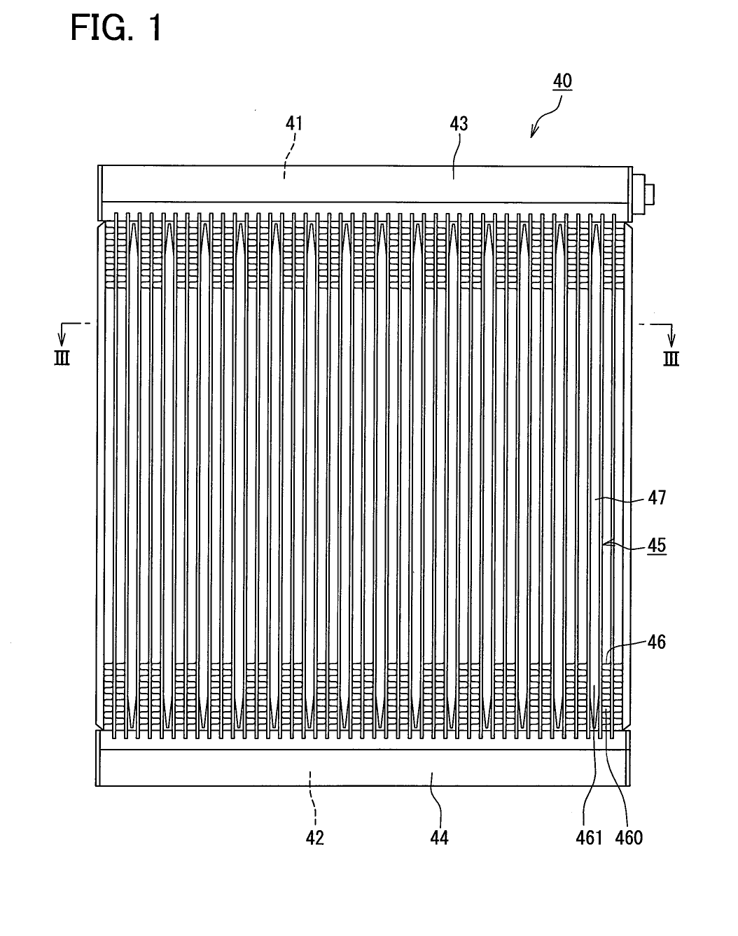

A first embodiment of the disclosure will be described, using FIG. 1 to FIG. 11. An evaporator 40 configures a refrigeration cycle device (not shown). The refrigeration cycle device is used in, for example, an air conditioning device for a vehicle. The refrigeration cycle device has a compressor, a radiator, and a pressure reducer, although these are omitted from the drawings, and the evaporator 40. These components are connected in ring form by piping, and configure a refrigerant circulation path. The compressor is driven by a propulsion energy source of the vehicle. When the energy source stops, the compressor also stops. The compressor suctions refrigerant from the evaporator 40, compresses the refrigerant, and discharges the refrigerant to the radiator. The radiator cools the high temperature refrigerant. The radiator is also called a condenser. The pressure reducer reduces the pressure of the refrigerant cooled by the radiator. The pressure reducer may be provided by a fixed throttle, a thermostatic expansion valve, or an ejector. The evaporator 40 causes the refrigerant whose pressure has been reduced by the pressure reducer to evaporate, thereby cooling the refrigerant. The evaporator 40 cools air supplied to the vehicle interior.

The refrigeration cycle device may further include an internal heat exchanger that exchanges heat between a high-pressure side liquid refrigerant and a low-pressure side gas refrigerant, and a tank element, which is a receiver or an accumulator in which excess refrigerant is stored. The energy source may be provided by an internal combustion engine or a motor.

The evaporator 40 is a cold storage heat exchanger, and has a refrigerant passage member divided into a multiple. The refrigerant passage member is provided by a passage member made of a metal such as aluminum. The refrigerant passage member is provided by headers 41 to 44 positioned to form pairs, and a multiple of refrigerant pipes 45 linking the headers 41 to 44.

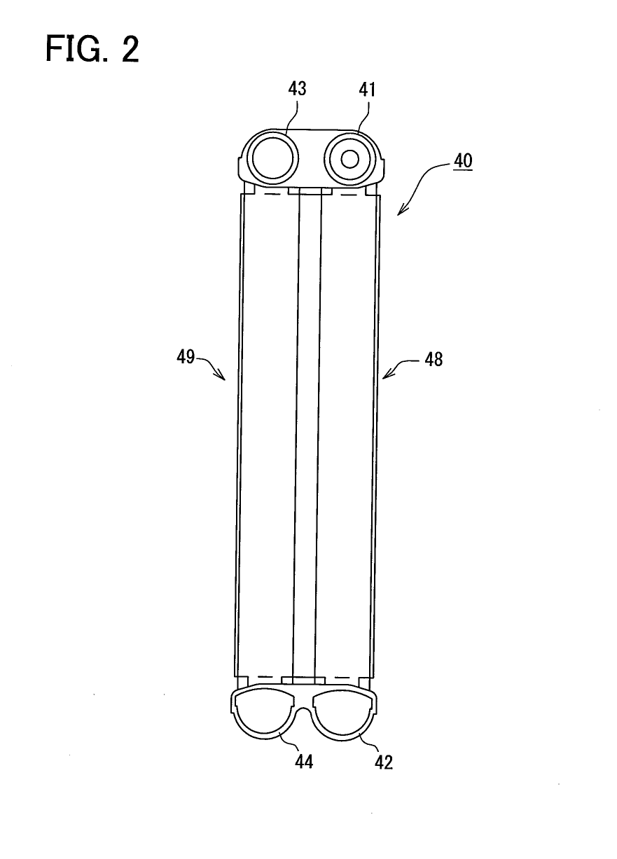

As shown in FIG. 1 and FIG. 2, the first header 41 and the second header 42 form a pair, and are disposed parallel to each other, separated by a predetermined distance. The third header 43 and the fourth header 44 form a pair, and are disposed parallel to each other, separated by a predetermined distance. The multiple of refrigerant pipes 45 are arrayed at equal intervals between the first header 41 and the second header 42. The multiple of refrigerant pipes 45 are arrayed at equal intervals between the third header 43 and the fourth header 44. Each refrigerant pipe 45 communicates at end portions thereof with the interiors of the corresponding headers.

As shown in FIG. 2, a first heat exchange unit 48 is provided by the first header 41, the second header 42, and the multiple of refrigerant pipes 45 disposed between the first header 41 and the second header 42. In the same way, a second heat exchange unit 49 is provided by the third header 43, the fourth header 44, and the multiple of refrigerant pipes 45 disposed between the third header 43 and the fourth header 44. As a result, the evaporator 40 has the first heat exchange unit 48 and the second heat exchange unit 49 disposed in two layers. The second heat exchange unit 49 is disposed on the upstream side, and the first heat exchange unit 48 is disposed on the downstream side, in the flow direction of air.

A joint (not shown) acting as a refrigerant inlet is provided in an end portion of the first header 41. The interior of the first header 41 is partitioned into a first section and a second section by a partitioning plate (not shown) provided approximately in the center in the longitudinal direction of the first header 41. Corresponding to this, the multiple of refrigerant pipes 45 are divided into a first group and a second group. Refrigerant is supplied to the first section of the first header 41. The refrigerant is distributed from the first section to the multiple of refrigerant pipes 45 belonging to the first group. The refrigerant passes through the first group, flows into the second header 42, and is collected. The refrigerant is distributed again from the second header 42 to the multiple of refrigerant pipes 45 belonging to the second group. The refrigerant passes through the second group, and flows into the second section of the first header 41. In this way, a path causing the refrigerant to flow in a U-form is provided in the first heat exchange unit 48.

A joint (not shown) acting as a refrigerant outlet is provided in an end portion of the third header 43. The interior of the third header 43 is partitioned into a first section and a second section by a partitioning plate (not shown) provided approximately in the center in the longitudinal direction of the third header 43. Corresponding to this, the multiple of refrigerant pipes 45 are divided into a first group and a second group. The first section of the third header 43 neighbors the second section of the first header 41. The first section of the third header 43 and the second section of the first header 41 are in communication.

The refrigerant flows from the second section of the first header 41 into the first section of the third header 43. The refrigerant is distributed from the first section to the multiple of refrigerant pipes 45 belonging to the first group. The refrigerant passes through the first group, flows into the fourth header 44, and is collected. The refrigerant is distributed again from the fourth header 44 to the multiple of refrigerant pipes 45 belonging to the second group. The refrigerant passes through the second group, and flows into the second section of the third header 43. In this way, a path causing the refrigerant to flow in a U-form is provided in the second heat exchange unit 49. The refrigerant in the second section of the third header 43 flows out from the refrigerant outlet, and flows toward the compressor.

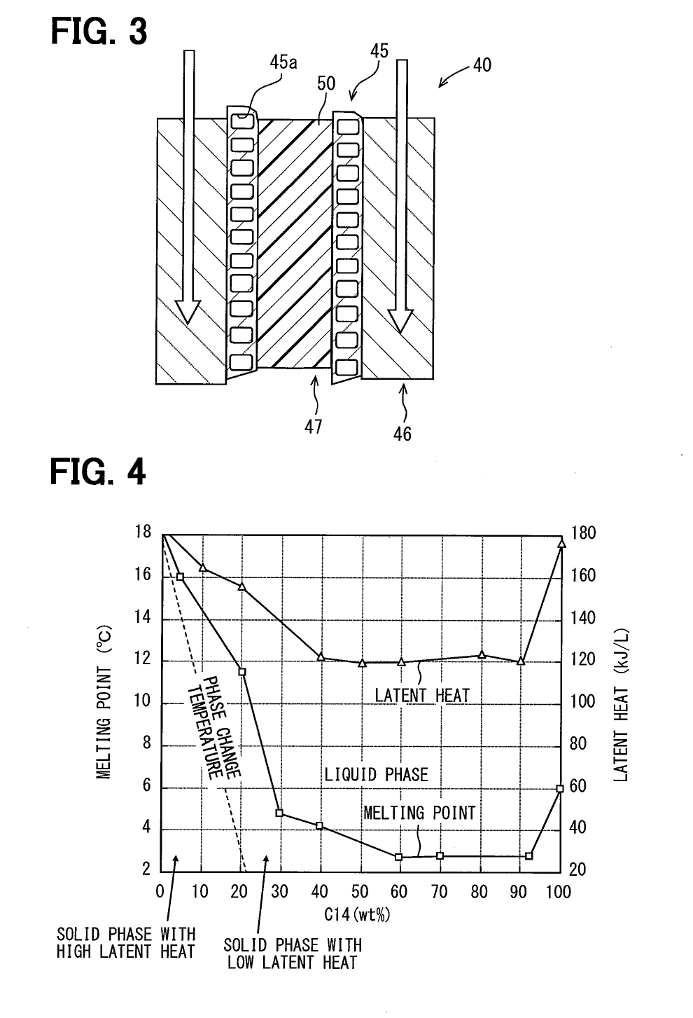

Next, a specific configuration of the refrigerant pipe 45 and the like will be described. In FIG. 3, the thickness of a cold storage container 47 is omitted from the drawing, while a cold storage medium 50 is shown with hatching applied. The refrigerant pipe 45 is a multi-hole pipe having in the interior thereof a multiple of refrigerant passages 45a along which refrigerant flows. The refrigerant pipe 45 is also called a flat pipe. The multi-hole pipe can be obtained using an extrusion method. The multiple of refrigerant passages 45a extend in the longitudinal direction of the refrigerant pipe 45, and open at both ends of the refrigerant pipe 45. The multiple of refrigerant pipes 45 are aligned to form rows. In each row, the multiple of refrigerant pipes 45 are disposed in such a way that the main surfaces thereof are opposed. An air passage 460, for exchanging heat with air, and a housing portion 461 for housing the cold storage container 47 are defined by the multiple of refrigerant pipes 45, and are located between two refrigerant pipes 45 adjacent to each other.

The evaporator 40 includes an outer fin 46 for increasing the area in contact with air supplied to the vehicle interior. The outer fin 46 is provided by a multiple of corrugated outer fins 46. The outer fin 46 is disposed in the air passage 460 defined between two neighboring refrigerant pipes 45. The outer fin 46 is thermally bonded to the two neighboring refrigerant pipes 45. The outer fin 46 is joined to the two neighboring refrigerant pipes 45 by a joining material with excellent heat conduction. A wax material can be used as the joining material. The outer fin 46 has a wavy form in which a thin plate made of metal such as aluminum is bent, and includes the air passage 460 called a louver.

Next, the cold storage container 47 will be described. The cold storage container 47 is a cold storage body, and defines a chamber for housing the cold storage medium 50 inside. The cold storage container 47 is of a flat tube form. The cold storage container 47 is closed by the tube being crushed in the thickness direction thereof at both ends in the longitudinal direction of the cold storage container 47, whereby a space for housing the cold storage medium 50 is provided in the cold storage container 47. The cold storage container 47 has a main surface on both faces thereof. Each of two main walls providing the two main surfaces is disposed parallel to the refrigerant pipe 45. The cold storage container 47 is disposed in a manner that at least one surface, both surfaces in this embodiment are in contact with the refrigerant pipe 45.

The cold storage container 47 is thermally bonded to the two refrigerant pipes 45 disposed on either side thereof. The cold storage container 47 is joined to the two neighboring refrigerant pipes 45 by a joining material with excellent heat conduction. A wax material, or a resin material such as an adhesive, can be used as the joining material. The cold storage container 47 is brazed to the refrigerant pipe 45. A large amount of wax material is disposed between the cold storage container 47 and the refrigerant pipe 45 in order to link the two over a wide sectional area. As the wax material, a foil of wax material is disposed between the cold storage container 47 and the refrigerant pipe 45. As a result, the cold storage container 47 exhibits good heat conduction with the refrigerant pipe 45.

The thickness of the cold storage container 47 is practically equal to the thickness of the air passage 460. Therefore, the thickness of the cold storage container 47 is practically equal to the thickness of the outer fin 46. The outer fin 46 and the cold storage container 47 are interchangeable. As a result of this, the arrangement pattern of a multiple of the outer fins 46 and a multiple of the cold storage containers 47 can be set with a high flexibility.

The length of the cold storage container 47 is practically equal to that of the outer fin 46. As a result of this, the cold storage container 47 occupies practically the whole of the housing portion 461 in the longitudinal direction, between the two neighboring refrigerant pipes 45. It is desirable that a gap between the cold storage container 47 and the headers 41 to 44 is filled with pieces of the outer fin 46, or with a filling material such as resin.

The multiple of refrigerant pipes 45 are disposed at practically constant intervals. A multiple of gaps are provided between the multiple of refrigerant pipes 45. The multiple of outer fins 46 and the multiple of cold storage containers 47 are disposed with a predetermined regularity in the multiple of gaps. Some of the gaps are the air passage 460. The remainder of the gaps is the housing portion 461 of the cold storage container 47. Of the total number of intervals provided between the multiple of refrigerant pipes 45, for example, 10% or more and 50% or less are taken to be the housing portion 461. The cold storage container 47 is disposed in the housing portion 461.

The cold storage container 47 is disposed in the dispersed state practically evenly over the whole of the evaporator 40. The two refrigerant pipes 45 positioned on either side of the cold storage container 47 define the air passage 46 for exchanging heat with air on the side opposite to that of the cold storage container 47. From another viewpoint, two refrigerant pipes 45 are disposed between the two outer fins 46, and furthermore, one group of the cold storage containers 47, in which the two cold storage containers 47 are taken to be one group, are disposed between the two refrigerant pipes 45.

The cold storage container 47 is made of a metal such as aluminum or an aluminum alloy. As a material other than aluminum of the cold storage container 47, for example, a material including a metal with an ionization tendency lower than that of hydrogen is used as a main material or as a component.

Next, the cold storage medium 50 will be described. The cold storage medium 50 is a material that exchanges heat with refrigerant flowing through the refrigerant passage 45a, and stores a quantity of heat from the refrigerant. The cold storage medium 50 stores heat from the refrigerant by solidifying, and releases stored heat to the exterior by melting.

Paraffin is used as the cold storage medium 50. The melting point and heat of fusion of the paraffin vary depending on the carbon number. As the relationship between carbon numbers 12 to 18 (C12 to C18) and the melting point and heat of fusion, for example, C12 has a melting point of −12° C. and a heat of fusion of 163 kJ/L. C13 has a melting point of −5° C. and a heat of fusion of 123 kJ/L. C14 has a melting point of 6° C. and a heat of fusion of 174 kJ/L. C15 has a melting point of 10° C. and a heat of fusion of 125 kJ/L. C16 has a melting point of 18° C. and a heat of fusion of 182 kJ/L. C17 has a melting point of 21° C. and a heat of fusion of 129 kJ/L. C18 has a melting point of 28° C. and a heat of fusion of 188 kJ/L.

That is, as the carbon number increases, the melting point becomes higher. The inventors search for paraffin that is capable of storing cold heat over a wide temperature range that does not deviate greatly from 0° C. to 20° C., which is the temperature range at which the air conditioning device operates. As the result, the inventors discover that it is good to mix paraffin with a low melting point (C12 to C15) and paraffin with a high melting point (C16 to C18), and that it is better to use C16 as the cold storage medium 50 with a high melting point, whose melting point is nearer the operating temperature and whose heat of fusion (hereafter also called latent heat) is high.

Herein, the reason why it is preferable that the melting point is higher than 0° C. will be explained. Water vapor in the air condenses, and adheres as liquid water to the evaporator 40 while cooling is in operation. Consequently, when the cold storage medium 50 is at 0° C. or lower, moisture adhering to the surfaces of the evaporator 40 and the cold storage container 47 solidifies. At this time, there is concern that the air passage 460 of the evaporator 40 will be blocked. If the air passage 460 is blocked, the performance of the evaporator 40 drops considerably. Consequently, as it is preferable that the temperature of the evaporator 40 is higher than 0° C., it is preferable that the melting point of the cold storage medium 50 is higher than 0° C.

Next, the reason why it is preferable that the melting point is 20° C. or lower will be explained. The temperature at which an occupant feels discomfort during idle-stop is approximately 20° C. This is due to the vehicle interior temperature rising, and to a smell generated by moisture adhering to the evaporator 40 evaporating, when the temperature is higher than 20° C. For example, when the air conditioning device is set to an internal air circulation mode, and used at a vehicle interior temperature of 25° C. to 28° C., the wet-bulb temperature, which is the temperature at which a smell is generated during idle-stop, is approximately 20° C., although this also depends on the metabolism and number of the occupants, and the kind of vehicle. Consequently, when the vehicle interior temperature reaches 20° C., control is carried out to restart the cooling operation in order that no smell is generated. When the melting point of the cold storage medium 50 is set lower than or equal to 20° C., all the cold heat stored in the cold storage medium 50 is consumed before reaching 20° C., such that efficient operation can be carried out.

In other words, the cold storage medium 50 including paraffin with a low melting point and paraffin with a high melting point, which are mixed, is capable of storing cold heat over a wide temperature range, in this embodiment. Specifically, the cold storage medium 50 includes a low carbon number paraffin and a high carbon number paraffin which are mixed. The low carbon number paraffin is paraffin including at least one paraffin from among paraffins with carbon number in a range higher than or equal to 12 and lower than or equal to 15. The high carbon number paraffin is paraffin with a carbon number higher than the highest carbon number of the paraffins with the low carbon number. The high carbon number paraffin includes at least one paraffin from among paraffins with carbon number in a range higher than or equal to 15 and lower than or equal to 18. In this embodiment, the high carbon number paraffin has a carbon number of 16. The low carbon number paraffin has a carbon number of 13.

Next, the mixture ratio will be described with reference to FIG. 4. The horizontal axis in FIG. 4 indicates the concentration of C14 by weight. Consequently, when the concentration of C14 by weight is 0%, the concentration of C16 by weight is 100%. Also, when the concentration of C14 by weight is 100%, the concentration of C16 by weight is 0%. As shown in FIG. 4, when the amount of C14 with the low melting point is increased for mixing with C16 with the high melting point, the melting point gradually decreases, and the latent heat also decreases.

There is a phase change temperature at which there is a transition from a solid phase with low latent heat to a solid phase with high latent heat when the temperature of the paraffin is further reduced below the melting point, as shown in FIG. 4. However, when the amount of C14 increases, the phase change temperature is lowered. In order to store a large amount of cold heat, it is necessary to further reduce the temperature below the melting point, thereby causing a transition to a solid phase with high latent heat. That is, for the sake of storing cold heat, extra energy is consumed.

In the evaporator 40, the refrigerant temperature, and the like, is controlled in order to prevent moisture in the air from solidifying on the surface of the evaporator 40, not to decrease to 0° C. or lower, and from hindering the air flow. However, depending on the combination and the mixture ratio of the paraffins, the phase change temperature decreases to 0° C. or lower, as in the example where C16 and C14 are mixed. Consequently, when using paraffin with the phase change temperature lower than or equal to 0° C., cold storage cannot be carried out as far as a solid phase with high latent heat.

Consequently, in order that a large amount of cold heat can be stored, it is preferable to select paraffins such that the phase change temperature is 0° C. or higher and that the phase change temperature is near the melting point. To this end, increasing the mixture amount of one of the paraffins is preferable. Furthermore, it is preferable that the mixture ratio thereof is higher than 75 wt % (concentration by weight). Furthermore, in order to make the melting point to have a wide range, it is preferable that the paraffin whose concentration is higher than 75 wt % is a paraffin with a high melting point. For example, in the example of C16 and C14, C16 has the concentration higher than 75 wt %.

In other words, the concentration by weight of low carbon number paraffin in the cold storage medium 50 is set to be lower than the concentration by weight of high carbon number paraffin. Specifically, the high carbon number paraffin is set to be higher than 75% in the concentration by weight and to be lower than 100% in the concentration by weight. Further, the low carbon number paraffin is set to be higher than 0% in the concentration by weight and to be lower than 25% in the concentration by weight.

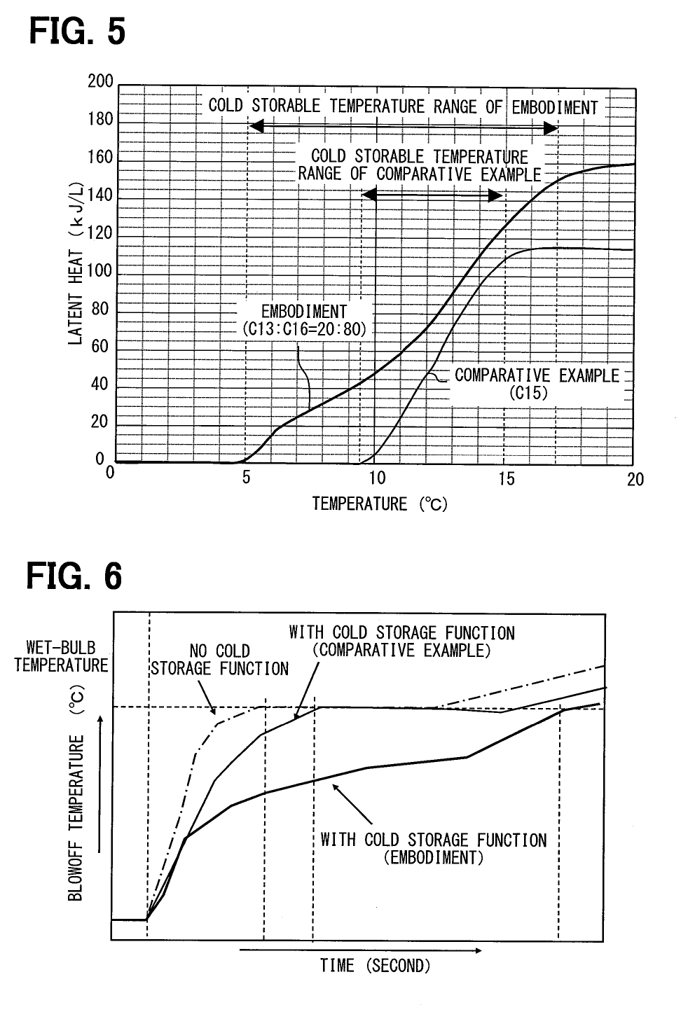

The relationship between the latent heat and the temperature of the cold storage medium 50 will be described with reference to FIG. 5. In this embodiment, low carbon number paraffin (C13) is of 20% concentration by weight, while high carbon number paraffin (C16) is of 80% concentration by weight. In FIG. 5, the waveform of paraffin whose carbon number is 15 is shown as a comparative example. As previously described, the cold storage medium 50 of the embodiment is made of a mixture of C13 having a melting point of −5° C. and C16 having a melting point of 18° C., at a percentage by weight of C13:C16=20:80. In this embodiment, latent heat can be stored over a wide melting point temperature range of approximately 5° C. to approximately 17° C. In contrast, the comparative example is C15 paraffin with a melting point of 10° C. Consequently, the range over which cold storage can be carried out in the comparative example is approximately 10° C. to approximately 15° C., which is smaller than in the embodiment.

The relationship between blow-off temperature and elapsed time will be described with reference to FIG. 6. The graph in FIG. 6 shows three kinds of waveform, those being of an evaporator with no cold storage function, an evaporator using a cold storage medium of a comparative example, and the evaporator 40 using the cold storage medium 50 of the embodiment. The blow-off temperature rises in a short time in the case of evaporator with no cold storage function. While the blow-off temperature of the evaporator of the comparative example rises in a short time, the temperature rise of the evaporator 40 of the embodiment is the gentlest. This is because the temperature range over which the paraffin of the embodiment can carry out cold storage is wide in comparison with that in the comparative example. Consequently, not only in summer when the external air is of a high temperature, but also in winter when the external air is of a low temperature of 10° C. or the like, a part of the cold storage medium 50 is in a melted state, while all the medium is constantly solidified in the comparative example, even when the engine or air conditioning device is stopped. A part of the cold storage medium 50 solidifies during operation of the air conditioning device, and melts again when the air conditioning device stops, such that an idle-stop time can be extended

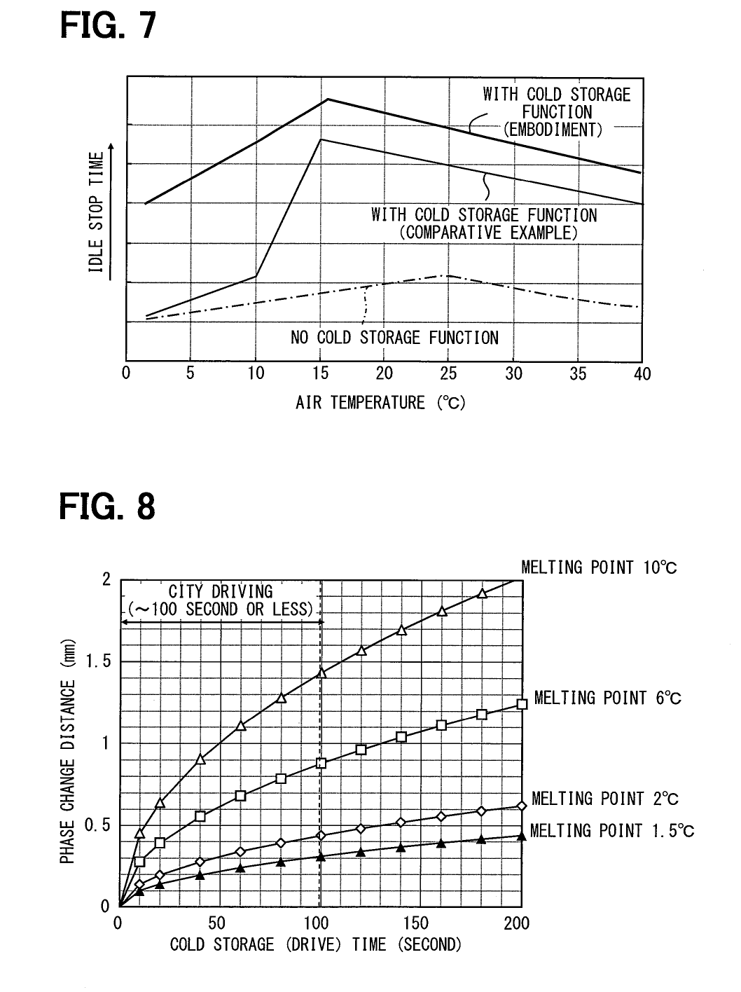

The relationship between the idle-stop time and air temperature will be described with reference to FIG. 7. The graph in FIG. 7 shows three kinds of waveform, those being of an evaporator with no cold storage function, an evaporator using a cold storage medium of a comparative example, and the evaporator 40 using the cold storage medium 50 of the embodiment. In the case of the evaporator with no cold storage function, the refrigerant temperature rises when the engine is stopped. Therefore, the idle-stop possible time is short regardless of the external air temperature. In the comparative example, when the air temperature is low, the cold storage medium is constantly solidified, and thus cannot release cold heat. Therefore, the idle-stop time is short when the intake temperature (air temperature) is low. Also, in the comparative example, cold storage and release can be obtained when the intake temperature exceeds the melting point (15° C.). In contrast, the cold storage medium 50 of the embodiment solidifies and melts over a wide range, because of which cold storage and release can be obtained over a wide range of intake temperature. In this way, it can be seen that the idle-stop time in the embodiment is longer in all temperature ranges than in the comparative example.

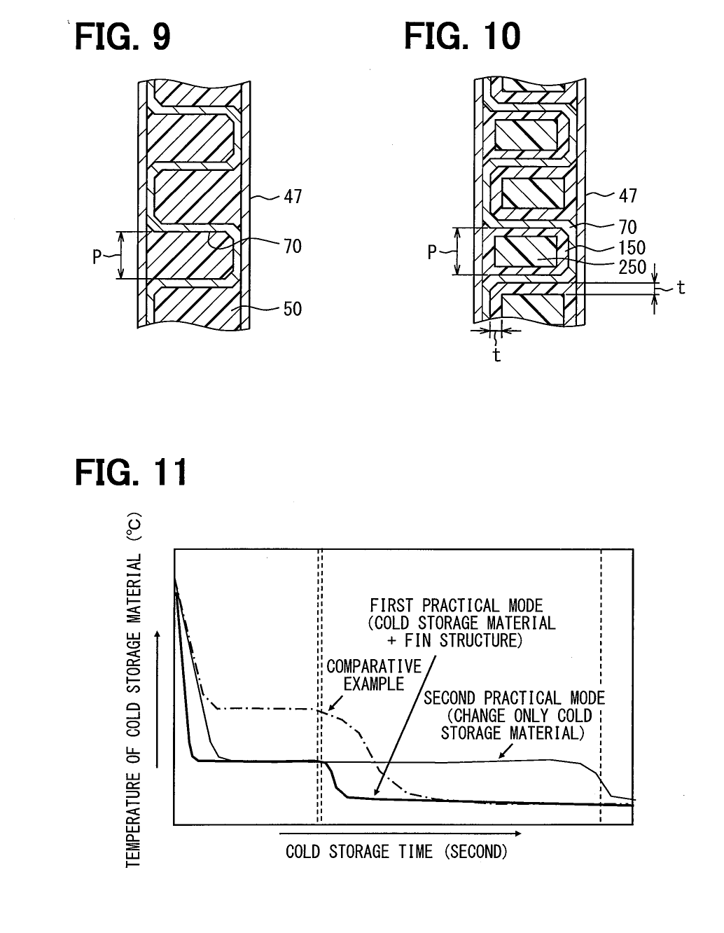

With reference to FIG. 8 to FIG. 10, the internal structure of the cold storage container 47 will be described. As shown in FIG. 9, an inner fin 70 is provided in the cold storage container 47. As the cold storage medium 50 can store cold heat only when the air conditioning device is operated by the engine driving, such as when traveling, the cooling time is limited. However, paraffin has low thermal conductivity. Further, when the cold storage medium 50 with a low melting point is used, as in the embodiment, the difference between the refrigerant temperature and the melting point decreases. Therefore, the heat transfer rate decreases, and a long cold storage time is needed. Phase change distance shown in FIG. 8 is the distance from a cooling surface (the inner surface of the cold storage container or the surface of the inner fin 70) to the solid-liquid boundary of the cold storage medium 50. As shown in FIG. 8, the phase change distance per unit time is made smaller as the melting point is lowered, as a relationship between the phase change distance and paraffins with melting points different from each other.

The solidification can be completed in a short time, as in FIG. 8, by reducing in advance the phase change distance needed for completing the solidification inside the cold storage container 47. When traveling in city, traveling and stopping are repeated within a short time, for example 100 seconds or less. In such an environment, it is preferable that the phase change distance in the cold storage container 47 is less than 0.5 mm. As a method of realizing the phase change distance of less than 0.5 mm, it is preferable that the inner fin 70, with an interval of less than 1 mm between peaks, is provided in the cold storage container 47, closely attached to the inner surface of the cold storage container 47 by brazing or the like.

Specifically, the inner fin 70 has a wave form curved in such a way that convex portions are alternately positioned on one side and the other side in the sectional form perpendicular to the flow direction of air flowing around the evaporator 40. The size of a fin pitch p, which is the distance between opposing inner wall faces in a convex portion of the sectional form of the inner fin 70, is set to be less than 1 mm.

FIG. 10 is a sectional view of the cold storage container 47, and shows a state where a part of the cold storage medium 50 is solidified. In FIG. 10, the cold storage medium 50 in a solidified state is indicated by reference sign 150, while the cold storage medium 50 in a state before solidifying is indicated by reference sign 250. As previously described, the cold storage medium 50 solidifies gradually from the surface of the inner fin 70. Consequently, the phase change distance may represent a thickness t of the cold storage medium 50 solidified from the surface of the inner fin 70. The cold storage medium 50 solidifies gradually from opposing inner wall faces of the inner fin 70 toward the center. Because of this, the cold storage medium 50 can be solidified within a predetermined time by setting the fin pitch p being less than 1 mm, even in the case where the phase change distance is less than 0.5 mm in the cold storage medium 50.

The relationship between the temperature of the cold storage medium 50 and cold storage completion time will be described with reference to FIG. 11. In a first practical mode, the cold storage medium 50 of the embodiment is used and the fin pitch p is set less than 1 mm. In a second practical mode, the cold storage medium 50 of the embodiment is enclosed in the cold storage container 47 having no inner fin 70. In a comparative example, a cold storage medium of the comparative example is enclosed in the cold storage container 47 having no inner fin 70. As shown in FIG. 11, the cold storage completion time of the first practical mode and the cold storage completion time of the comparative example barely differ. As opposed to this, the cold storage completion time of the second practical mode is considerably longer. Consequently, the advantage of shortening cold storage time by inserting the inner fin 70 is clear.

When the fin pitch p is reduced, the volume of the inner fin 70 in the cold storage container 47 increases, and the amount of paraffin that can be enclosed inside the cold storage container 47 decreases by the increase in the volume of the inner fin 70. Because of this, the amount of cold heat that can be stored also decreases. However, the cold storage medium 50 with a low melting point is used mainly when the external air temperature is low (such as in winter). At this time, as the thermal environment burden is small, the cold storage medium 50 is not so necessary. Consequently, the necessary amount of cold storage material can be secured even when the fin pitch p is less than 1 mm.

Next, an operation in this embodiment will be described. When there is an air conditioning request such as cooling request from an occupant, the compressor is driven by an energy source. The compressor takes in refrigerant from the evaporator 40, and compresses and discharges the refrigerant. The refrigerant discharged from the compressor emits heat in the radiator. The pressure of the refrigerant coming out of the radiator is reduced by the pressure reducer, and the refrigerant is supplied to the evaporator 40. The refrigerant evaporates in the evaporator 40 to cool the cold storage container 47, and cools the ambient air via the outer fin 46. When the vehicle stops temporarily, the energy source stops in order to reduce energy consumption, and the compressor stops. Subsequently, the refrigerant in the evaporator 40 gradually loses cooling capacity. In this process, the cold storage medium 50 gradually releases cold heat, thereby cooling the air. At this time, the heat of the air is conducted to the cold storage medium 50 through the outer fin 46, the refrigerant pipe 45, and the cold storage container 47. As a result of this, even when the refrigeration cycle device stops temporarily, the air can be cooled by the cold storage medium 50. When the vehicle starts traveling again, the energy source drives the compressor again. Because of this, the refrigeration cycle device cools the cold storage medium 50 again, and the cold storage medium 50 stores cold heat.

As previously described, the cold storage medium 50 of this embodiment includes low carbon number paraffin and high carbon number paraffin. The low carbon number paraffin has a comparatively low melting point, while the high carbon number paraffin has a comparatively high melting point. The temperature range over which the cold storage medium 50 solidifies and melts can be widened by using at least two kinds of paraffin with differing melting points as the cold storage medium 50. Because of this, the cold storage medium 50 can melt and release cold heat even when the air temperature is low. Consequently, even when the air temperature is low, the temperature can be maintained at or below the wet-bulb temperature of air passing through, whereby the generation of a smell accompanying the evaporation of condensed water can be restricted. Also, as the temperature range over which the cold storage medium 50 can store and release cold heat is wide, the cold storage function can be maintained over a wider range of air temperatures.

In other words, cold storage can be carried out over a wide range of temperatures, as the cold storage medium 50 of this embodiment is made of the mixture of paraffin with a low melting point and paraffin with a high melting point. Because of this, the idle-stop time can be secured not only in summer, as is the case with the existing technology, but also in winter (in an environment of 10° C. or below).

Also, in this embodiment, the high carbon number paraffin of the cold storage medium 50 has a carbon number of 16. The concentration by weight of the low carbon number paraffin is less than the concentration by weight of the high carbon number paraffin. Thus, the cold storage medium 50 can store latent heat over a wide temperature range of melting points.

Furthermore, in this embodiment, the high carbon number paraffin has a concentration by weight higher than 75% and less than 100%. Also, the low carbon number paraffin has a concentration by weight higher than 0% and less than 25%. As described using FIG. 4, it is preferable that the phase change temperature is near the melting point, because of which it is preferable to adopt the previously described mixture amounts. By so doing, a large amount of cold heat can be stored.

Furthermore, in this embodiment, the inner fin 70 is provided in the cold storage container. The low carbon number paraffin does not include paraffin with a carbon number of 15. The low carbon number paraffin includes at least one paraffin from among paraffins with a carbon number higher than or equal to 12 and lower than or equal to 14. The inner fin 70 has the wavy sectional form, and the size of the fin pitch p is less than 1 mm. Because of this, even in the case where the phase change distance is small, the cold storage medium 50 can be caused to solidify within the predetermined time, as the fin pitch p is small. In other words, paraffin has low heat conductivity, and furthermore, considerable time is required for cold storage when the melting point is reduced by including C12 or C13. Therefore, the solidification time can be reduced by reducing the fin pitch p to reduce the phase change distance of the paraffin.

### Second Embodiment

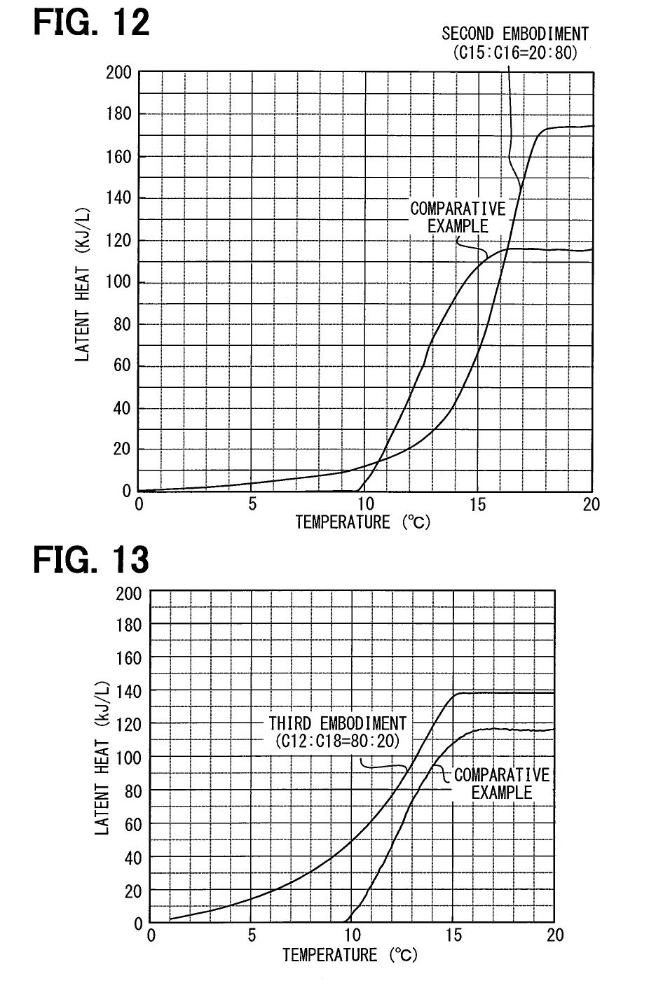

A second embodiment will be described with reference to FIG. 12, in which paraffins used in the cold storage medium 50 are modified. The cold storage medium 50 used in the evaporator 40 of the second embodiment is called the cold storage medium 50 of a second example. In FIG. 12, a waveform of paraffin with a carbon number of 15 is shown as a comparative example.

In the second embodiment, C16 (melting point 18° C.) is used as high carbon number paraffin, while C14 (melting point 6° C.) or C15 (melting point 10° C.) is used as low carbon number paraffin. Further, the low carbon number paraffin has a concentration by weight lower than that of the high carbon number paraffin. Regarding the concentrations by weight, for example, C16 has a concentration by weight of 75% or more and less than 100%, while C14 or C15 has a concentration by weight higher than 0% and lower than 25%.

In the second embodiment shown in FIG. 12, C15 and C16 are mixed at a weight percentage of C15:C16=20:80. Because of this, latent heat can be stored over a wide temperature range of melting points from approximately 10° C. to approximately 18° C. As opposed to this, the comparative example is C15 paraffin with a melting point of 10° C. Consequently, the range over which cold storage can be carried out in the comparative example is approximately 10° C. to approximately 15° C., which is small in comparison with the second embodiment.

In this way, in this embodiment, the temperature range over which the cold storage medium 50 solidifies and melts can be widened, in the same way as in the first embodiment. Consequently, the same effects and advantages as in the first embodiment can be achieved.

### Third Embodiment

A third embodiment will be described with reference to FIG. 13, in which paraffins used in the cold storage medium 50 are modified. The cold storage medium 50 used in the evaporator 40 of the third embodiment is called the cold storage medium 50 of a third example. In FIG. 13, a waveform of paraffin with a carbon number of 15 is shown as a comparative example.

In the third embodiment, C16, C17 (melting point 21° C.), or C18 (melting point 28° C.) is used as high carbon number paraffin. Preferably, C17 or C18 is used as high carbon number paraffin, which has a melting point of 20° C. or more. In this case, the high carbon number paraffin has a concentration by weight lower than that of C12 to C15, which are paraffins with a low carbon number. Regarding the concentrations by weight, it is preferable that the high carbon number paraffin has a concentration by weight, for example, higher than 0% and lower than 40%, while C12 to 15 have a concentration by weight higher than 60% and lower than 100%.

In the third embodiment shown in FIG. 13, C12 and C18 are mixed at a weight percentage of C12:C18=80:20. Because of this, latent heat can be stored over a wide temperature range of melting points from approximately 1° C. to approximately 15° C. As opposed to this, the comparative example is C15 paraffin with a melting point of 10° C. Consequently, the range over which cold storage can be carried out is approximately 10° C. to approximately 15° C., which is small in comparison with the third embodiment.

Although C17 or C18 is used in this embodiment, the melting point of C17 and C18 used solely is higher than or equal to 20° C., which is extremely high with respect to the cooling temperature of the air conditioning device. Consequently, the melting point is regulated to an appropriate range by including a larger amount of C12 to C15 having low melting point. Because of this, the temperature range over which the cold storage medium 50 solidifies and melts can be widened, in the same way as in the first embodiment. Consequently, the same effects and advantages as in the first embodiment can be achieved.

### Fourth Embodiment

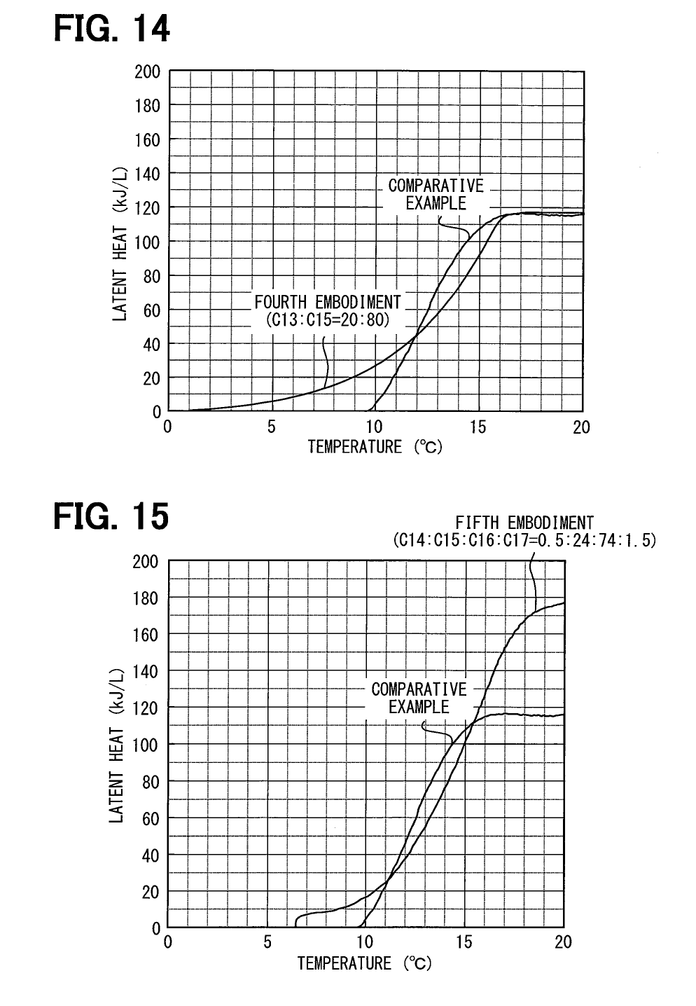

A fourth embodiment will be described with reference to FIG. 14, in which the paraffins used in the cold storage medium 50 are modified. The cold storage medium 50 used in the evaporator 40 of the fourth embodiment is called the cold storage medium 50 of a fourth example. In FIG. 14, a waveform of paraffin with a carbon number of 15 is shown as a comparative example.

In the fourth embodiment, C15 or C16 is used as high carbon number paraffin, without using paraffin of C17 or higher, while C12 or C13 is used as low carbon number paraffin. The low carbon number paraffin has a concentration by weight lower than that of the high carbon number paraffin. Regarding the concentrations by weight, for example, it is preferable that C15 or C16 has a concentration by weight of 60% or higher and 100% or lower, while C12 or C13 has a concentration by weight of 0% or higher and 40% or lower.

In the fourth embodiment shown in FIG. 14, C13 and C15 are mixed at a weight percentage of C13:C15=20:80. Because of this, latent heat can be stored over a wide temperature range of melting points from approximately 1° C. to approximately 16° C. As opposed to this, the comparative example is C15 paraffin with a melting point of 10° C. Consequently, the range over which cold storage can be carried out is approximately 10° C. to approximately 15° C., which is small in comparison with the fourth embodiment.

In this embodiment, even when using C15, which has the highest melting point among C12 to C15, as the high carbon number paraffin, without using C16, the melting point is within an appropriate range, as previously described. Because of this, the temperature range over which the cold storage medium 50 solidifies and melts can be widened, in the same way as in the first embodiment. Consequently, the same effects and advantages as in the first embodiment can be achieved.

### Fifth Embodiment

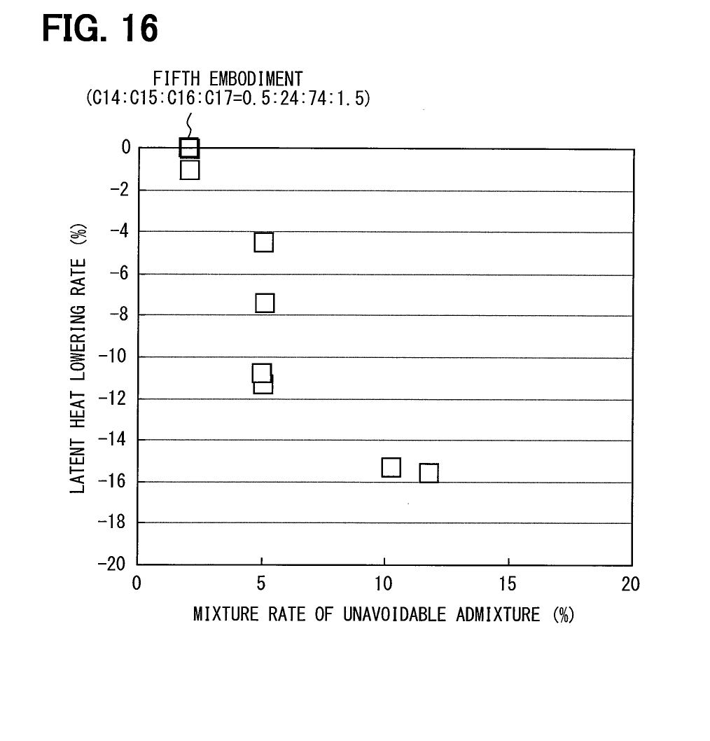

A fifth embodiment will be described with reference to FIG. 15 and FIG. 16, in which the paraffins used in the cold storage medium 50 are modified. The cold storage medium 50 used in the evaporator 40 of the fifth embodiment is called the cold storage medium 50 of a fifth example. In FIG. 15, a waveform of paraffin with a carbon number of 15 is shown as a comparative example.

In the fifth embodiment, at least one of C16 to C18 is used as high carbon number paraffin, while at least one of C12 to C15 is used as low carbon number paraffin. The low carbon number paraffin has a concentration by weight lower than that of the high carbon number paraffin. Regarding the concentrations by weight, it is preferable that, for example, the high carbon number paraffin has a concentration by weight of 60% or higher and 100% or lower, while the low carbon number paraffin has a concentration by weight higher than 0% and lower than 40%. Furthermore, it is preferable that the concentration by weight of an unavoidable compound including C12 to C18 paraffins, excluding the high carbon number paraffin and the low carbon number paraffin, is higher than 0% and lower than 5%. It is preferable that the unavoidable compound comprises at least one paraffin of the paraffins with carbon numbers 14 and 17.

In the fifth embodiment shown in FIG. 15, C14 to C17 are mixed at a weight percentage of C14:C15:C16:C17=0.5:24:74:1.5. Consequently, the concentration by weight of the unavoidable compound is 2.0, which is the total concentration by weight of C14 and C17. The unavoidable compound is made of paraffins whose carbon numbers are 14 and 17. Because of this, latent heat can be stored over a wide temperature range of melting points from approximately 6.5° C. to approximately 19° C. As opposed to this, the comparative example is C15 paraffin with a melting point of 10° C. Consequently, the range over which cold storage can be carried out is approximately 10° C. to approximately 15° C., which is small in comparison with the fifth embodiment.

When the concentration of unavoidable compound is 5% or more, the latent heat lowering rate increases, as shown in FIG. 16. Consequently, it is preferable that the total concentration by weight of the unavoidable compound is higher than 0% and lower than 5%, as previously described. In this embodiment, the concentration by weight of the unavoidable compound is, for example, 2%, and the cold storage medium 50 of the fifth embodiment having the kind of characteristics shown in FIG. 15 can be obtained. In this way, the same effects and advantages as in the first embodiment can be achieved.

### Sixth Embodiment

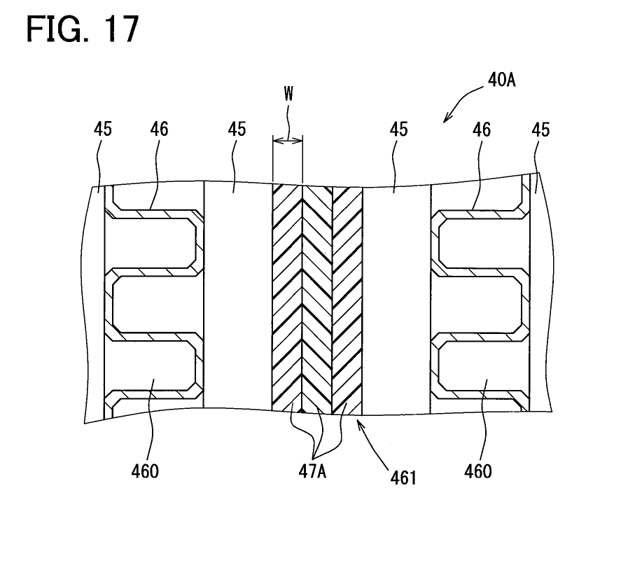

A sixth embodiment will be described with reference to FIG. 17, in which the cold storage container is modified in the shape. In this embodiment, a multiple of cold storage containers 47A are stacked in the housing portion 461. The cold storage medium 50, in which carbon numbers 12 to 15 are used as low carbon number paraffin, is enclosed in each cold storage container 47A. Further, an internal width W of each cold storage container 47A is set to be less than 1 mm. In other words, a refrigerant pipe providing a refrigerant passage is disposed on at least one side of the cold storage container, and the interval between the internal wall of the cold storage container on the one side and another internal wall opposing the internal wall on the one side is less than 1 mm.

In this embodiment, even when there is no inner fin 70 in the cold storage container 47A, unlike the first embodiment, solidification time can be reduced by the cold storage container 47A itself being made thin. Because of this, even in the case of a cold storage medium 50 with a small phase change distance, the cold storage medium 50 can be caused to solidify within the predetermined time owing to the cold storage container 47A being thin.

Although no inner fin 70 is provided in the cold storage container 47A in this embodiment, the inner fin 70 may be provided. The solidification time can be further reduced by the inner fin 70 being provided.

Also, in this embodiment, three cold storage containers 47A are stacked in the housing portion 461 but, the number is no limited to three. One, two, or four or more cold storage containers 47A may be provided.

### Seventh Embodiment

A seventh embodiment will be described with reference to FIG. 18, in which the arrangement of cold storage container is modified. A multiple, two in this embodiment, of cold storage containers 47B are disposed between two neighboring refrigerant pipes 45. The cold storage containers 47B are arrayed in the flow direction of the intake air. Also, each cold storage container 47B houses differing cold storage media 50a and 50b in the same housing portion 461.

A high carbon number paraffin and a low carbon number paraffin are mixed in each cold storage medium 50a and 50b in a manner that the melting point ranges of the cold storage media 50a and 50b differ from each other. Because of this, cold storage can be carried out over a wider temperature range using two kinds of mixed paraffin than when using one kind of mixed paraffin.

Also, in order to correspond to a case where, for example, the air temperature is high, the cold storage medium 50 of the first practical mode of the first embodiment may be enclosed in one cold storage container 47B, while C16 paraffin is used as the cold storage medium 50 in the other cold storage container 47B. In this case, the melting point in the cold storage container 47B in which C16 is enclosed is high such that the phase change speed is sufficiently high. Therefore, there is no need to provide the inner fin 70 in the cold storage container 47B in which C16 is enclosed.

### Eighth Embodiment

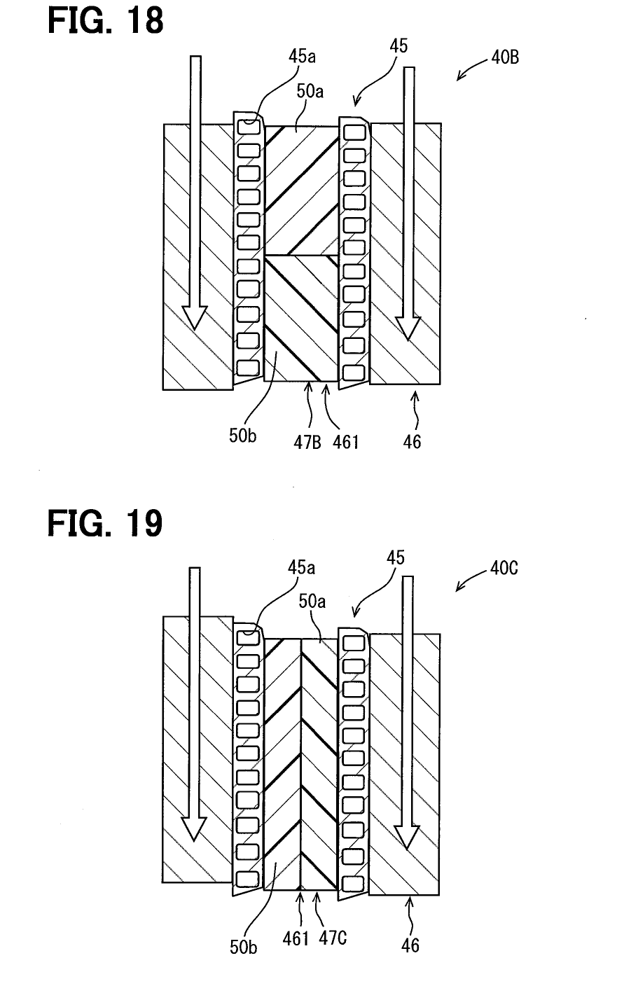

An eighth embodiment will be described with reference to FIG. 19, in which the arrangement of cold storage container is modified. A multiple, two in this embodiment, of cold storage containers 47C are disposed between two neighboring refrigerant pipes 45. The cold storage containers 47C are arrayed in a direction perpendicular to the flow direction of the intake air. In other words, the cold storage containers 47C are stacked in the direction in which the refrigerant pipes 45 are disposed leaving an interval. Also, the cold storage containers 47C house differing cold storage media 50a and 50b in the same housing portion 461. Because of this, in the same way as in the seventh embodiment, cold storage can be carried out over a wider temperature range using two kinds of mixed paraffin than when using one kind of mixed paraffin.

### Other Embodiment

While the desirable embodiment of the present disclosure is described, the present disclosure is not restricted to the embodiment mentioned, and can be implemented with various modification in the range not deviating from the scope of the present disclosure.

The structures of the above embodiments are merely exemplary, and technical scopes of the disclosure are not limited to the disclosed scopes. The technical scope of the disclosure is represented by the claims, and includes meanings equivalent to those of the claims, and all changes in the scope.

In the first embodiment, the cold storage media 50 enclosed in each cold storage container 47 are mutually equivalent, but a configuration wherein the cold storage media 50 are equivalent is not limiting. For example, mutually differing cold storage media 50 may be enclosed in neighboring cold storage containers 47, as in the seventh embodiment and the eighth embodiment. In this way too, the same effects and advantages as in the seventh embodiment and the eighth embodiment can be achieved.

Also, additives may be added to the composition of the cold storage medium 50 to an extent such as not to affect the latent heat of melting of the paraffin. For example, a hydrogen generation inhibitor, an antioxidant, or the like, may be used as an additive.

In the first embodiment, a cold storage body is realized by the cold storage container 47, but the cold storage container 47 that houses only the cold storage medium 50 in the interior thereof is not limiting. Consequently, the cold storage body may be a member such that, for example, a multiple of members are combined, demarcating rooms that house a cold storage medium in the interior thereof. In other words, for example, the cold storage body may be such that one plate is distorted into an S form, the apertures thereof are covered with another member, one space houses a cold storage medium, and a refrigerant or the like may be housed in another space.

The refrigerant pipe 45 can be provided by a multi-hole extruded pipe, or by a pipe such that sheet metal in which dimples are provided is bent into a tube form. Furthermore, the outer fin 46 can be omitted. This kind of heat exchanger is also called a finless type. Exchange of heat with the air may be promoted by providing a ridge or the like extending out of the refrigerant pipe in place of the outer fin 46.

The disclosure can be applied to evaporators having various kinds of flow path. For example, in addition to the kind of left-right U-turn type of the first embodiment, the disclosure may be applied to evaporators of a one-direction type, a front-back U-turn type, or the like.

Furthermore, the disclosure may be applied to refrigeration cycle devices for cooling, heating, supplying hot water, or the like. Furthermore, the disclosure may be applied to a refrigeration cycle device including an ejector.

What is claimed is:

1. A cold storage heat exchanger that exchanges heat with air flowing therearound, the cold storage heat exchanger comprising:
a refrigerant passage through which refrigerant flows; and
a cold storage body housing a cold storage medium that exchanges heat with refrigerant flowing through the refrigerant passage and stores an amount of heat from the refrigerant, wherein
the cold storage medium includes
a low carbon number paraffin comprising at least one of C12 paraffin and C13 paraffin, and
a high carbon number paraffin comprising at least one of C15 paraffin and C16 paraffin,
a concentration of the high carbon number paraffin in the cold storage medium is higher than 60 percent by weight and lower than 100 percent by weight, and
a concentration of the low carbon number paraffin in the cold storage medium is higher than 0 percent by weight and lower than 40 percent by weight.

2. A cold storage heat exchanger that exchanges heat with air flowing therearound, the cold storage heat exchanger comprising:
a refrigerant passage through which refrigerant flows; and
a cold storage body housing a cold storage medium that exchanges heat with refrigerant flowing through the refrigerant passage and stores an amount of heat from the refrigerant, wherein
the cold storage medium includes
a low carbon number paraffin comprising at least one of C14 paraffin and C15 paraffin, and
a high carbon number paraffin comprising at least one of C15 paraffin and C16 paraffin, a carbon number of the high carbon number paraffin being higher than the highest carbon number included in the low carbon number paraffin,
a concentration of the high carbon number paraffin in the cold storage medium is higher than 75 percent by weight and lower than 100 percent by weight, and
a concentration of the low carbon number paraffin in the cold storage medium is higher than 0 percent by weight and lower than 25 percent by weight.

3. A cold storage heat exchanger that exchanges heat with air flowing therearound the cold storage heat exchanger comprising:
a refrigerant passage through which refrigerant flows; and
a cold storage body housing a cold storage medium that exchanges heat with the refrigerant flowing through the refrigerant passage and stores an amount of heat from the refrigerant, wherein
the cold storage medium includes
a low carbon number paraffin comprising at least one of paraffins having carbon numbers higher than or equal to 12 and lower than or equal to 15, and
a high carbon number paraffin comprising at least one of paraffins having carbon numbers higher than or equal to 16 and lower than or equal to 18,
a concentration of the high carbon number paraffin in the cold storage medium is higher than 0 percent by weight and lower than 40 percent by weight, and
a concentration of the low carbon number paraffin in the cold storage medium is higher than 60 percent by weight and lower than 100 percent by weight.

4. A cold storage heat exchanger that exchanges heat with air flowing therearound, the cold storage heat exchanger comprising:
a refrigerant passage through which refrigerant flows; and
a cold storage body housing a cold storage medium that exchanges heat with the refrigerant flowing through the refrigerant passage and stores an amount of heat from the refrigerant, wherein
the cold storage medium includes
a low carbon number paraffin comprising at least one of paraffins having carbon numbers higher than or equal to 12 and lower than or equal to 15, and
a high carbon number paraffin comprising at least one of paraffins having carbon numbers higher than or equal to 16 and lower than or equal to 18,
a concentration of the high carbon number paraffin in the cold storage medium is higher than 60 percent by weight and lower than 100 percent by weight,
a concentration of the low carbon number paraffin in the cold storage medium is higher than 0 percent by weight and lower than 40 percent by weight, and
a concentration of an unavoidable compound including a paraffin, which is a paraffin excluding the low carbon number paraffin and the high carbon number paraffin, with a carbon number higher than or equal to 12 and lower than or equal to 18 is higher than 0 percent by weight and lower than 5 percent by weight.

5. The cold storage heat exchanger according to claim 4, wherein the unavoidable compound comprises at least one paraffin of C14 paraffin and C17 paraffin.

6. The cold storage heat exchanger according to claim 1, further comprising:
a fin provided inside of the cold storage body, wherein
the fin has a wavy sectional form curved in such a way that a convex portion is alternately positioned on one side and the other side, and a distance between opposing inner wall faces in the convex portion is less than 1 mm.

7. The cold storage heat exchanger according to claim 1, wherein
a refrigerant pipe providing the refrigerant passage is disposed on at least one side of the cold storage body, and
an interval between an internal wall of the cold storage body on the one side and another internal wall opposing the internal wall on the one side is less than 1 mm.
